(19) United States
(12) Patent Application Publication
(10) Pub. No.: US 2011/0086588 A1
(43) Pub. Date: Apr. 14, 2011

(54) FAN NOZZLE WITH ADJUSTING RING FOR SWIVELING AIR GUIDING ELEMENTS

(75) Inventor: Dino DEMMA, Russelsheim (DE)

(73) Assignee: GM GLOBAL TECHNOLOGY OPERATIONS, INC., Detroit, MI (US)

(21) Appl. No.: 12/902,909

(22) Filed: Oct. 12, 2010

(30) Foreign Application Priority Data
Oct. 12, 2009 (DE) 102009049116.3

(51) Int. Cl. B60H 1/24

(52) U.S. Cl. 454/162

(57) ABSTRACT

A fan nozzle for an air outlet of a motor vehicle fan includes, but is not limited to a substantially centrically arranged center piece, at least one air guiding element that can be swiveled about a swivel axis oriented radially to the center piece, an adjusting lever substantially oriented perpendicularly to the swivel axis for swiveling the air guiding element and a rotatable adjusting ring for swiveling the adjusting lever. The adjusting ring includes, but is not limited to a slot substantially oriented perpendicularly to the swivel axis for accommodating the adjusting lever. The slot in an axial direction towards the air guiding element includes, but is not limited to an opening for inserting the adjusting lever, and the adjusting lever is accommodated in the slot. Through the slot opened in axial direction the adjusting lever connected with the air guiding element can be directly actuated by the adjusting ring so that a pin perpendicularly standing away from the adjusting lever is not required and can be saved.

### CROSS-REFERENCE TO RELATED APPLICATION

This application claims priority to German Patent Application No. 102009049116.3, filed Oct. 9, 2009, which is incorporated herein by reference in its entirety.

### TECHNICAL FIELD

The invention relates to a fan nozzle for an air outlet of a motor vehicle fan, wherein the fan nozzle can swivel air guiding elements with the help of a rotatable adjusting ring in order to be able to adjust a volumetric flow and/or a flow direction of a fan flow of a motor vehicle ventilation system.

### BACKGROUND

From DE 10 2007 010 795 A1 a fan nozzle is known, wherein air guiding elements articulated with a center piece centrically arranged in a flow channel and oriented radially can be swiveled with the help of an adjusting ring arranged radially outside. To this end, the air guiding elements each comprise an adjusting lever oriented perpendicularly to the swivel axis, from which adjusting lever a pin inserted in a slot of the adjusting ring closed all round stands away parallel to the respective swivel axis. Upon rotation of the adjusting ring the pin is imparted a movement component in axial direction by the slot, which leads to a swivel movement of the associated air guiding element, so that the fan nozzle can be opened and closed depending on the position of the adjusting ring.

Disadvantageous with such a fan nozzle are the complicated construction and the necessary close tolerances so that the air guiding elements can be inserted in the adjusting ring and upon rotation of the adjusting ring do not jam.

It is at least one object of the invention to create a fan nozzle for an air outlet of a motor vehicle fan which makes possible a simple construction and low tolerance requirements. In addition, other objects, desirable features and characteristics will become apparent from the subsequent summary and detailed description, and the appended claims, taken in conjunction with the accompanying drawings and this background.

### SUMMARY

The fan nozzle for an air outlet of a motor vehicle fan according to an embodiment of the invention comprises a center piece substantially arranged centrically and at least one air guiding element capable of being swiveled about a swivel axis running radially to the center piece. Furthermore, an adjusting lever substantially oriented perpendicularly to the swivel axis for swiveling the air guiding element and a rotatable adjusting ring for swiveling the adjusting lever are provided. According to an embodiment of the invention, the adjusting ring comprises a slot substantially oriented perpendicularly to the swivel axis for accommodating the adjusting lever, wherein the slot in axial direction towards the air guiding element comprises an opening for inserting the adjusting lever and the adjusting lever is accommodated in the slot.

Through the slot opened in axial direction the adjusting lever connected with the air guiding element can be directly actuated by the adjusting ring, so that a pin standing away perpendicularly from the adjusting lever is not required and can be saved. Through the component reduction thus achievable the construction of the fan nozzle is simplified and tolerance requirements of the moveable parts relative to each other reduced. With a plurality of air guiding elements the swivel axes more preferably run through a common center point, wherein the axial direction to all radially oriented swivel axes of the air guiding elements is aligned perpendicularly. The axial direction substantially corresponds to the flow direction of the completely opened fan nozzle if no spin elements or other air diversions are provided. The center piece is more preferably arranged centrically to the adjusting ring so that the adjusting ring and the center piece are substantially arranged coaxially relative to each other. More preferably it is possible to insert the adjusting lever in the adjusting ring through an axial movement of the adjusting ring, so that during the assembly of the fan nozzle a radial movement of an adjusting ring constructed in multiple parts is not required. Because of this, the assembly of the fan nozzle is simplified. Since with the air guiding element a pin standing away from the adjusting lever can be saved, the risk is reduced that with the air guiding element components standing away could break off for example during transport. More preferably the air guiding elements and the adjusting ring are designed with fewer undercuts so that the manufacture, for example through plastic injection molding, can be simplified. For example it is possible during plastic injection molding of the adjusting ring to save cores to be inserted individually for forming the slot of the adjusting ring.

Particularly preferably the slot expands in axial direction towards the air guiding element. The slot can more preferably diverge for example funnel-like in a part region towards the open end, wherein towards the axial opening the extent of the widening can progressively increase in order to achieve a bent course of the funnel. Through the widening in axial direction towards the air guiding element it can be ensured that the adjusting lever does not jam in the slot. Through the widening it can be taken into account that the adjusting lever because of its swivel movement changes its orientation within the slot. Because of this it can be taken into account that for opening and closing the fan nozzle the air guiding element can be swiveled in an angular range of approximately 90° and the adjusting lever within the slot of the adjusting ring also changes its orientation likewise by approximately 90°. More preferably, the adjusting lever is connected with the air guiding element in such a manner that the adjusting lever can be adjusted between approximately −45° and approximately +45° substantially between a completely closed position of the fan nozzle and substantially a completely opened position of the fan nozzle based on the orientation of the slot, more preferably in axial direction. Because of this, the maximum inclined position of the adjusting lever within the slot can be minimized. At the same time, it can be taken into account through the slot that because of the swivel movement of the adjusting lever the adjusting lever describes an offset in axial direction. Here it is preferred if when turning the adjusting ring a contact point of the adjusting lever reaches the region of the widening before reaching the completely closed position and/or the completely opened position of the air guiding element. Because of this, the speed of the air guiding elements is automatically reduced before reaching the planned end position with constant rotational speed of the adjusting ring so that the air guiding element strikes a stop, if provided for example a neighboring air guiding element, with a smaller impulse.

Preferentially the adjusting lever comprises a lever arm and at an end facing away from the swivel axis a lever head following the lever arm, wherein the lever head transversely to the swivel axis at least partially has a greater extension than the lever arm. Because of this, the adjusting lever can be constructed thicker at the end facing away from the swivel axis than the remaining adjusting lever. In particular it is possible that only the lever head slides along an inner surface of the slot upon a movement of the adjusting ring without the remaining adjusting lever striking the inner surface of the slot in the region of the lever arm. Because of this, jamming of the adjusting lever within the slot is avoided. Furthermore the tolerance requirements become particularly low since it is merely required that the lever head fits into the slot. If greater play results between the lever head and the slot a brief period merely results when changing the direction of rotation of the adjusting ring in which the air guiding elements are not swiveled. The function of swiveling the air guiding elements with the help of the adjusting lever accommodated in the slot is not impaired.

More preferably the lever head is at least partially rounded. Through the rounded construction of the lever head it can be achieved that upon movement of the adjusting ring the inner surface of the slot substantially contacts the lever head only at a point. Because of this, the friction between the lever head and the slot is reduced and easier sliding of the lever head in the slot is achieved. The lever head can more preferably be constructed as part of a ball.

Preferentially in every position the lever arm is spaced from an inner surface of the slot. To this end, the lever arm can be constructed suitably thin and/or the slot can be constructed suitably widened in the region of the lever arm. Because of this it is avoided that the lever arm can strike the inner surface of the slot so that jamming of the adjusting lever within the slot is avoided. Furthermore, the tolerance requirements can be lowered since through the provided spacing between the lever arm and the inner surface of the slot a suitably high safety for the swivel movement of the adjusting lever within the slot is provided.

In a preferred embodiment the adjusting lever is constructed flat in the direction of the swivel axis. The adjusting lever is more preferably constructed flat on the lateral surface facing to the outside in the direction of the swivel axis and on the lateral surface facing to the inside in the direction of the swivel axis. Because of this, pins or shoulders standing away from the adjusting lever are avoided. The adjusting lever is more preferably constructed as flat profile wherein the adjusting lever for forming a thickened lever head can be constructed suitably contoured perpendicularly to the swivel axis.

Particularly preferably the adjusting ring comprises at least two, preferentially at least four, particularly preferably at least six slots, wherein all slots are formed through exactly one unitary adjusting ring element. Segmenting of the adjusting ring with a plurality of part ring segments is not required. Because of the unitary formation it is not necessary that individual part segments have to be joined together during the assembly of the fan nozzle. In particular, tolerances in circumferential direction are avoided.

In a preferred embodiment at least two, preferentially at least four, particularly preferably at least six air guiding elements that can be simultaneously swiveled by the adjusting ring are provided, wherein the air guiding elements in the closed state of the fan nozzle partially overlap and more preferably on the end facing away from the swivel axis comprise a step for bearing against a neighboring air guiding element in the region of the swivel axis of the neighboring air guiding element. Through the overlapping air guiding elements, substantially complete closing of the fan nozzle can be achieved so that no significant volumetric flow of a fan flow can pass through the fan nozzle. Through the step on the lateral end of the air guiding element it can be achieved that in the closed state of the fan nozzle the air guiding elements substantially form a common flat surface. Because of this, the surface of the air guiding elements visible by a vehicle occupant can form a substantially stepless closed surface which intuitively signals a completely closed fan nozzle. In this position of the air guiding elements a vehicle occupant as a rule will have no reason for further rotating the adjusting ring in order to close the fan nozzle. Damaging the fan nozzle by a vehicle occupant is avoided because of this.

More preferably, the at least one adjusting lever is arranged radially outside or radially inside on the air guiding element. If the adjusting levers are arranged radially inside the adjusting ring can likewise be arranged radially inside in the region of the center piece. If the adjusting lever is arranged radially outside, the adjusting ring can likewise be positioned outside. It is more preferably possible to arrange the adjusting levers both radially inside as well as radially outside and to provide an adjusting ring both radially inside as well as radially outside. A vehicle occupant can then adjust the fan nozzle in the inner or in the outer region as desired by rotating the adjusting ring. The inner adjusting ring can be separated from the outer adjusting ring or interconnected via additional braces.

Preferentially the adjusting ring comprises a gripping surface accessible to a user for rotating the adjusting ring, wherein the gripping surface more preferably comprises anti-slip elements, preferentially a multiplicity of knobbles, grooves or depressions. Via the gripping surface, the adjusting ring can be directly rotated by a user, for example a vehicle occupant, in order to swivel the air guiding elements. Through the anti-slip elements the hold or the friction between a hand of the user and the gripping surface can be increased so that the hand of the user does not unintentionally slip off the gripping surface of the adjusting ring.

More preferably the center piece comprises a hub for accommodating an axle or shaft oriented perpendicularly to the swivel axis. Because of this it is possible via the center piece to remove forces that occur with the help of a co-rotating shaft or fixed axle. This increases the stability of the fan nozzle and facilitates secure mounting of the air guiding elements on the center piece.

Preferentially the air guiding element is connected directly rotatably with the center piece. For example the center piece comprises an opening in which a pivot of the air guiding elements is rotatably inserted or vice versa. For the air guiding element and the center piece a material pairing is more preferably selected which leads to the formation of a slide bearing. Because of this it is not required to provide a rolling bearing between the air guiding element and the center piece.

Particularly preferably the air guiding element is mounted radially outside in a housing element relative to which the adjusting ring is moveable, wherein more preferably the adjusting ring is slidably fitted on to the housing element. The housing element more preferably comprises an opening which is more preferably opened in axial direction in order to be able to axially insert and mount a pivot more preferably arranged between the adjusting lever and the remaining air guiding element. For the housing element and the air guiding element a material pairing is more preferably selected through which a slide bearing can be formed. A rolling bearing arranged between the air guiding element and the housing element can thus be saved. At the same time, the housing element can comprise the additional function of centering and/or guiding the adjusting ring. Between the housing element and the adjusting ring a slide bearing can be formed likewise through a suitable material pairing in order to facilitate rotating of the adjusting ring in contact with the housing element.

Preferentially the adjusting ring comprises a window and the adjusting ring is moveable relative to an information surface, wherein through the window upon a movement of the adjusting ring various information of the information surface can be exposed. Upon rotation of the adjusting ring the window is automatically moved along so that the position of the window is moved relative to the information surface which is more preferably part of a fixed housing element. Because of this it the extent to which the fan nozzle is opened or closed with the current position of the adjusting ring can be visually displayed, in that for example corresponding symbols are made visible through the window that is also moved along. At the same time, when rotating the adjusting ring, a user receives visual feedback as to whether the fan nozzle is opened or closed as intended. The risk of operating error of a fan nozzle is thus reduced.

The embodiments of the invention furthermore relate to a motor vehicle fan, more preferably a ball fan comprising a housing forming an air outlet for arrangement in a flow channel of a motor vehicle ventilation system. A fan nozzle for adjusting a volumetric flow and/or a flow direction of a fan flow is connected with the housing, wherein the fan nozzle can be designed and further developed as described above. Through the slot of the adjusting ring opened in axial direction towards the air guiding element it is possible to directly insert the adjusting lever into the slot without additional components in order to open and close the fan nozzle. This results in simplified construction subject to reduced tolerance requirements.

### BRIEF DESCRIPTION OF THE DRAWINGS

The present invention will hereinafter be described in conjunction with the following drawing figures, wherein like numerals denote like elements, and:

FIG. 1 is a schematic perspective view of a motor vehicle fan with a fan nozzle;

FIG. 2 is a schematic perspective view of the motor vehicle fan from FIG. 1 with an only partially shown fan nozzle;

FIG. 3 is a schematic perspective part-sectioned view of the fan nozzle from FIG. 1 in the closed state; and

FIG. 4 is a schematic perspective part-sectioned view of the fan nozzle from FIG. 3 in the open state.

### DETAILED DESCRIPTION

The following detailed description is merely exemplary in nature and is not intended to limit application and uses. Furthermore, there is no intention to be bound by any theory presented in the preceding background or summary or the following detailed description.

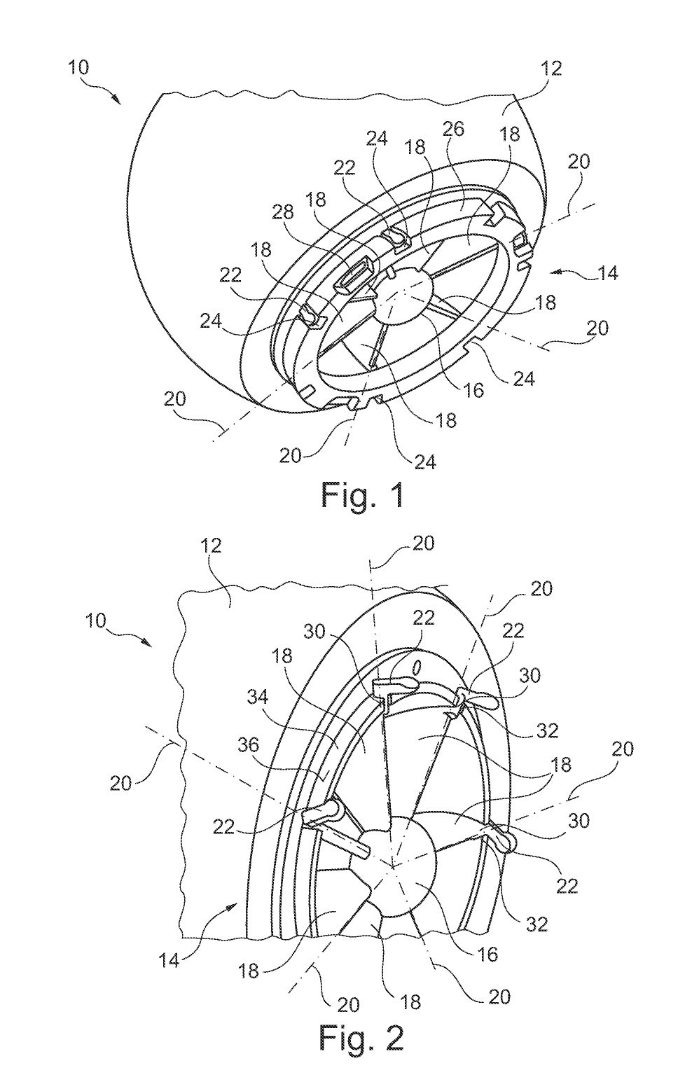

The motor vehicle fan 10 shown in FIG. 1 substantially comprises a partially ball-shaped housing 12 for inserting in a corresponding receiving housing of a flow channel of a motor vehicle ventilation system in order to form a ball fan. At an air outlet of the motor vehicle fan 10 a fan nozzle 14 is provided which comprises a center piece 16 arranged centrically to the air outlet. In the exemplary embodiment shown, six air guiding elements 18 are connected with the center piece 16 in a manner capable of being swiveled. The air guiding elements 18 can each be swiveled about a swivel axis 20. On its radially outer end in the direction of the swivel axis 20 an adjusting lever 22 each is provided with each air guiding element 18. The adjusting lever 22 substantially starts in the region of the swivel axis 20 and substantially runs perpendicularly to the swivel axis 20 away from the swivel axis 20. The adjusting lever 22 is accommodated in a slot 24 of an adjusting ring 26. The slot 24 is opened in axial direction towards the air guiding elements 18 so that the adjusting lever 22 can be inserted in the slot 24 in axial direction. In the exemplary embodiment shown the slot 24 is also opened at its other axial end that is in axial direction directed away from the air guiding elements 18.

The adjusting ring 26 comprises fastening openings 28 for clipping a lid for the adjusting ring 26 which is not shown to the adjusting ring 26. Through the lid for the adjusting ring 26 which is not shown a gripping surface can be provided so that a user can manually rotate the adjusting ring 26. Upon rotation the adjusting ring 26 is moved in circumferential direction as a result of which the adjusting lever 22 is swiveled. The slot 24 is dimensioned in such a manner that the adjusting lever 22 during its swivel movement cannot jam within the slot 24. Through the use of the adjusting lever 22 the air guiding elements 18 are also swiveled along so that by rotating the adjusting ring 26 the air guiding elements 18 can be swiveled in order to open and/or close the fan nozzle 14.

As can be seen in FIG. 2, because of the adjusting ring 26 which is not shown, the air guiding elements 18 are mounted via a pivot 30 arranged between the adjusting lever 22 and the air guiding element 18 in a corresponding bearing opening 32 of a housing element 34 opened in axial direction. The housing element 34 can comprise a sliding surface 36 facing radially to the outside on which the adjusting ring 26 can be rotatably fitted. The adjusting ring 26 can slide along the sliding surface 36 when the adjusting ring 26 is rotated.

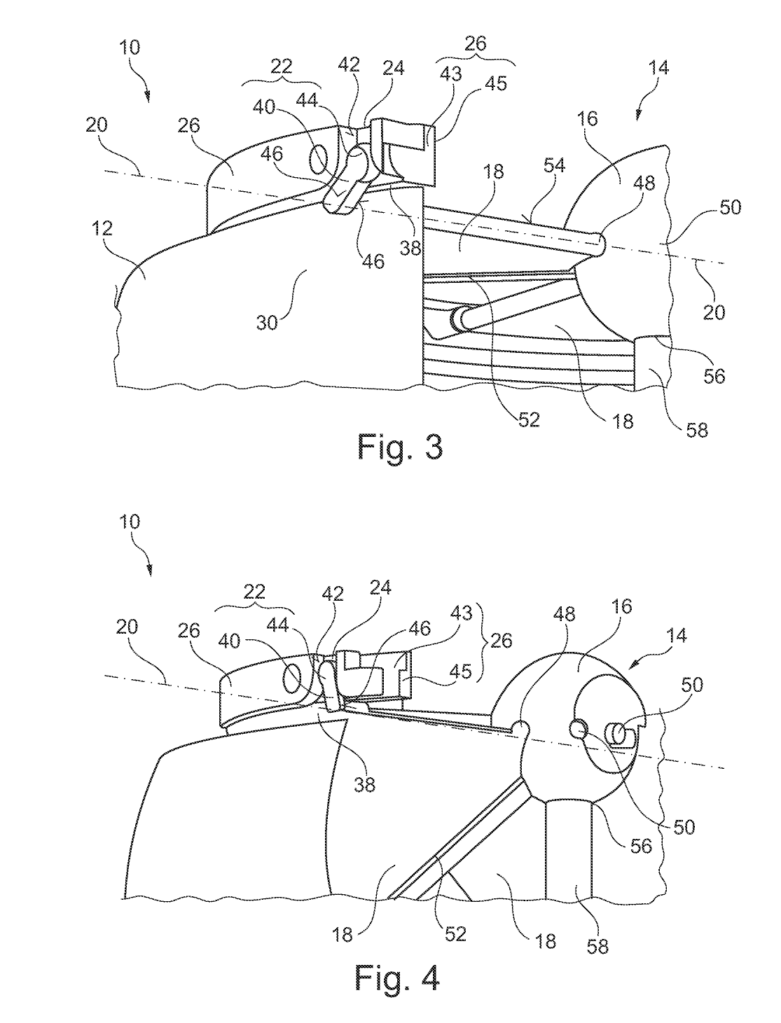

As is shown in FIG. 3 the slot 24 comprises an opening 38 in axial direction towards the air guiding elements 18 via which the adjusting lever 22 can be inserted in the slot 24. The slot 24 widens funnel-like with the opening 38 as widest point. Because of this it is ensured that a lever arm 40 of the adjusting lever 22 cannot strike an inner surface 42 of the slot 24. Merely a lever head of the adjusting lever 22 is in contact with the inner surface 42 of the slot 24. The lever head 44 is arranged on an end of the lever arm 40 of the adjusting lever 22 facing away from the swivel axis 20. The lever head 44 comprises a greater extension transversely to the swivel axis 20 than the lever head 44. The lever head 44 thus has a greater thickness so that the lever arm 40 does not strike the inner surface 42 of the slot 24. Here, the lever head 44 is of a rounded design and in the exemplary embodiment shown configured as disc-shaped part of a ball. Because of this a merely a point contact between the lever head 44 and the inner surface 42 of the slot 24 is ensured.

In the exemplary embodiment shown the adjusting ring 26 is embodied as composite material with a plurality of components. The adjusting ring 26 comprises an outer adjusting ring element 43 and an inner adjusting ring element 45 connected with the outer adjusting ring element. Both the outer adjusting ring element 43 as well as the inner adjusting ring element 45 are closed in circumferential direction and not assembled of a plurality of part segments. The outer adjusting ring element forms all slots 24 for all adjusting levers 22 of the air guiding elements 18 arranged radially outside.

On the lateral surfaces 46 of the adjusting lever 22 facing radially inside and radially outside in the direction of the swivel axis 20, no components standing away are arranged so that the lateral surfaces 46 are embodied flat. Radially inside the air guiding elements 18 are each mounted in a blind hole 50 of the center piece 16 via an inner pivot 48. The air guiding elements 18 at their side facing away from the swivel axis 20 comprise a step 52 which in the closed state can bear against a neighboring air guiding element 18. This makes possible positioning the air guiding elements 18 in the closed state with a surface 54 located in a common plane while closing the fan nozzle 14 as tightly as possible at the same time.

As is shown in FIG. 4, the air guiding elements in the opened position of the fan nozzle 14 have been swiveled by approximately 90° compared with the situation shown in FIG. 3. The adjusting lever 22 has also been swiveled within the slot 24 by approximately 90°. Because of the substantially funnel-shaped configuration of the slot 24 the adjusting lever 22 does not strike the inner surface 42 of the slot 24 in the region of the lever arm 40. In every position of the adjusting lever arm the lever arm 40 is spaced from the inner surface 42 of the slot 24. For swiveling the air guiding elements 18 by approximately 90° the adjusting ring 26 is merely rotated somewhat in order to swivel the adjusting lever 22 accommodated in the slot 24 about the swivel axis 20.

The center piece 16 comprises a hub 56 in which a fixed axle 58 of the motor vehicle fan 10 is permanently inserted.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A fan nozzle for an air outlet of a motor vehicle fan, comprising:
a center piece substantially arranged centrically;
a first air guiding element adapted to swivel about a swivel axis oriented radially to the center piece;
an adjusting lever substantially oriented perpendicularly to the swivel axis and adapted to swivel the first air guiding element; and
a rotatable adjusting ring adapted to swivel the adjusting lever,
wherein the rotatable adjusting ring comprises a slot substantially oriented perpendicularly to the swivel axis and adapted to accommodate the adjusting lever,
wherein the slot in an axial direction towards the first air guiding element comprises an opening adapted for inserting the adjusting lever, and
wherein the adjusting lever is accommodated in the slot.

2. The fan nozzle according to claim 1, wherein the slot is adapted to expand in the axial direction towards the first air guiding element.

3. The fan nozzle according to claim 1,
wherein the adjusting lever comprises a lever arm and at an end facing away from the swivel axis comprises a lever head following the lever arm,
wherein the lever head, transversely to the swivel axis, at least partially has a greater extension than the lever arm.

4. The fan nozzle according to claim 3, wherein the lever head is at least partially rounded.

5. The fan nozzle according to claim 3, wherein the lever arm in every position is spaced from an inner surface of the slot.

6. The fan nozzle according to claim 1, wherein the adjusting lever is substantially flat in a swivel direction of the swivel axis.

7. The fan nozzle according to claim 1, wherein the rotatable adjusting ring comprises at least two slots and all the at least two slots are formed through a unitary adjusting ring element.

8. The fan nozzle according to claim 1, wherein the rotatable adjusting ring comprises at least four slots and all the at least four slots are formed through a unitary adjusting ring element.

9. The fan nozzle according to claim 1, wherein the rotatable adjusting ring comprises at least six slots and all the at least six slots are formed through a unitary adjusting ring element.

10. The fan nozzle according to any one of the claim 1, a second air guiding element adapted to a substantially simultaneously swivel with the first air guiding element by the rotatable adjusting ring, wherein the first air guiding element and the second air guiding element in a closed state of the fan nozzle partially overlap and at an end facing away from the swivel axis comprise a step for bearing against a neighboring air guiding element in a region of the swivel axis of the neighboring air guiding element.

11. The fan nozzle according to claim 1, wherein the adjusting lever is arranged radially outside on the first air guiding element.

12. The fan nozzle according to claim 1, wherein the adjusting lever is arranged radially inside on the first air guiding element.

13. The fan nozzle according to claim 1, wherein the rotatable adjusting ring comprises a gripping surface for rotating the rotatable adjusting ring accessible to a user, wherein the gripping surface comprises anti-slip elements.

14. The fan nozzle according to claim 1, wherein the center piece comprises a hub adapted to accommodate an axle oriented perpendicularly to all swivel axes.

15. The fan nozzle according to claim 1, wherein the first air guiding element is connected directly rotatably with the center piece.

16. The fan nozzle according to claim 1, wherein the first air guiding element is mounted radially outside in a housing element relative to which the rotatable adjusting ring is moveable, wherein the rotatable adjusting ring is slidably fitted on to the housing element.

17. The fan nozzle according to claim 1, wherein the rotatable adjusting ring comprises a window and the rotatable adjusting ring is adapted to move relative to an information surface, wherein through the window upon movement of the rotatable adjusting ring different information of the information surface can be exposed.

18. A motor vehicle fan, comprising:
a housing adapted to form an air outlet for arrangement in a flow channel of a motor vehicle ventilation system; and
a fan nozzle connected with the housing, the fan nozzle comprising: a center piece substantially arranged centrically;
a first air guiding element adapted to swivel about a swivel axis oriented radially to the center piece;
an adjusting lever substantially oriented perpendicularly to the swivel axis and adapted to swivel the first air guiding element; and
a rotatable adjusting ring adapted to swivel the adjusting lever,
wherein the rotatable adjusting ring comprises a slot substantially oriented perpendicularly to the swivel axis and adapted to accommodate the adjusting lever,
wherein the slot in an axial direction towards the first air guiding element comprises an opening adapted for inserting the adjusting lever, and
wherein the adjusting lever is accommodated in the slot.
